(19) United States
(12) Patent Application Publication
(10) Pub. No.: US 2018/0139168 A1
(43) Pub. Date: May 17, 2018

(54) METHOD FOR COMMUNICATING BETWEEN AT LEAST TWO TERMINALS, AND A CORRESPONDING TERMINAL

(71) Applicants: Sebastian Lang, Walldorf (DE); Philipp Gabler, Mannheim (DE); Raim Koo, Edinburgh (GB)

(72) Inventors: Sebastian Lang, Walldorf (DE); Philipp Gabler, Mannheim (DE); Raim Koo, Edinburgh (GB)

(21) Appl. No.: 15/529,728

(22) PCT Filed: Nov. 25, 2014
(86) PCT No.: PCT/DE2014/200653

§ 371 Date: Dec. 21, 2017

(51) Int. Cl. H04L 12/58; G06F 3/14; H04L 29/08; G06F 3/0484

(52) U.S. Cl. CPC H04L 51/36; G06F 3/1407; G06F 2203/04804; G06F 3/04845; H04L 67/306

(57) ABSTRACT

A method for communication between at least two terminals (1, 2) via a network, wherein a first terminal (1) comprising a display device (3), at least one second terminal (2) and an information unit are provided, wherein the information unit transfers information data (6) to the first terminal (1), preferably via the network, wherein the second terminal (2) transfers communication data (16) to the first terminal (1) via the network, wherein the communication data (16) are presented on a first visual plane (18) of the display device (3) and wherein the information data (6) are presented on a second visual plane (19) of the display device (3). A terminal for applying the method is described.

The invention relates to a method for communication between at least two terminals via a network. Furthermore, the invention relates to a terminal for applying the method.

Methods of the type in question have been known from practice for years. For example, so-called chat programmes and chat protocols enable communication between users of at least two terminals via networks, such as the internet. In the simplest embodiment, communication data in the form of mere text messages are, therein, exchanged between the terminals. Furthermore, there are chat programmes and chat protocols which, in addition to exchanging text messages, provide the possibility to transfer further communication data, for example, pictures, video or audio sequences or the user's current position data.

The communication data are presented to the users as messages on the graphical user interface (GUI) of the display of their terminal. Therein, the presentation may vary depending on the chat programme used as well as on the terminal.

Sometimes, mobile worldwide communication is enabled by corresponding methods.

The methods known so far for communication between at least two terminals are problematic in that, although nowadays they enable reliable communication, they do not provide any further functions which do not relate to the mere transfer of communication data. Particularly when using mobile terminals, the user is limited to the presentation of the communication data during communication, due to the small size of the terminal and therefore the associated small dimensions of the display device of the terminal.

Therefore, the object of the present invention is to design and refine a method for communication between two terminals of the aforementioned type such that an extension of the functionality of the method is achieved for the user by using technically simple means. Furthermore, a terminal for applying the method is to be presented.

The above problem is solved according to the invention by means of the features of Claim 1. According thereto, a first terminal comprising a display device, at least one second terminal and an information unit are provided, wherein the information unit transfers information data to the first terminal, preferably via the network, wherein the second terminal transfers communication data to the first terminal via the network, wherein the communication data are presented on a first visual plane of the display device and wherein the information data are presented on a second visual plane of the display device.

In accordance with the invention, it has initially been discovered that the functionality of a method for communication between at least two terminals via a network can be extended in an amazingly simple manner by providing an information unit in addition to the first terminal and the second terminal. The information unit can be used to transfer information data to the first terminal, with the result that, in addition to merely exchanging communication data, it is now also possible to transfer further information data to the first terminal, at least information data that do not directly relate to the communication. Furthermore, the second terminal transfers communication data to the first terminal via the network.

Still in accordance with the invention, it has been discovered that the communication data and the information data can be presented on the display device of the first terminal in a particularly sophisticated manner by presenting the communication data on a first visual plane of the display device and by presenting the information data on a second visual plane of the display device.

Therein, the first visual plane can be disposed in the foreground of the second visual plane, this being particularly advantageous for a viewer of the display device. In such a presentation, the information data are therefore presented in the background of the communication data or such that they are overlapped by the communication data. In this embodiment, the first visual plane represents the graphical user interface (GUI) whereas the second visual plane forms a background of the GUI.

As an alternative, it is conceivable that, for a viewer, the second visual plane is disposed in the foreground of the first visual plane. In such a presentation, the communication data are presented in the background of the information data or such that they are overlapped by the information data.

It is also conceivable that further visual planes are provided for displaying data.

To simplify the presentation, the communication data of the first visual plane can, at least in part, be presented transparently and/or semi-transparently. Consequently, the communication data of the first visual plane which, for example, appears in the foreground are easily recognised—for example, read—by a viewer, wherein the information data presented in the background on the second visual plane can be distinguished by a viewer in an almost unrestricted manner without the communication data having a disturbing effect therein.

To further optimise the distinguishability of information data and communication data, the presentation of the colours and/or the brightness of the communication data on the first visual plane can, at least in part, be adjusted to the presentation of the colours and/or the brightness of the information data on the second visual plane. Consequently, the contrast between the communication data that overlap the information data can be optimised for a viewer by using simple technical means, this resulting in a considerable improvement of the distinguishability of communication data and information data.

Advantageously, the information data may be an animation and/or moving pictures and/or audiovisual sequences, more particularly promotional videos, video streams, movie trailers, etc. Therein, it is furthermore conceivable that, while the audiovisual sequence is running and/or after it has been running, the user has the possibility to obtain further information about the promotional video, video stream, movie trailer, etc. the user has just played back. Therein, a hyperlink can, for example, be embedded in the audiovisual sequence. Furthermore, it is conceivable that the user can interact with the audiovisual sequence while the audiovisual sequence is running and/or after it has been running. In particular, it can be provided that the audiovisual sequence can be stopped or discarded, its loudness can be adjusted or the size of the display can be changed. As an alternative or supplement, it can be provided that the user changes the transparency and/or the colour and/or the contrast of the communication data and/or the information data, for adjusting a simultaneous perception of the communication data and the information data that is ideal for the user.

In further advantageous manner, the information data can be presented in full screen mode or in a smaller size and/or with a lower resolution than the resolution of the display device. Consequently, the presentation can be ideally adjusted to the user's references and to the terminal used.

In order to allow communication for the users that is as multifunctional as possible, the communication data can be messages, particularly text messages, audible sequences, audiovisual sequences, pictures, video clips, graphics, current position data of the users and/or emoticons.

Furthermore, it is conceivable that the first terminal and/or the second terminal is/are a desktop computer, a laptop, a notebook, a tablet computer, a smart phone, a PDA, etc. This enables communication across platforms and terminals.

In particularly advantageous manner, the information unit can be implemented by the first terminal and/or by the second terminal and/or by an external processing unit that communicates via the network and comprises a server and at least one database and/or by a computer infrastructure that communicates via the network and is offered by one or a plurality of information providers. Consequently, the information unit can be implemented by a single or by a plurality of systems. At this point, it should be noted that the term “computer infrastructure” should be understood in the broadest sense. Such an infrastructure can, for example, be the infrastructure of a provider of video sequences, a news service, a weather service, etc.

Advantageously, the information data to be transferred to the first terminal are selected by a selection unit. Therein, it is conceivable that the selection unit is implemented by the first terminal or by the external processing unit. In particularly advantageous manner, the information data to be transferred from the selection unit to the first terminal can be selected in due consideration of selection data. Therein, the selection data can be transferred from the first terminal and/or the second terminal and/or the external processing unit and/or the computer infrastructure to the selection unit.

In particularly advantageous manner, the selection data can be the personal data of a user of the first terminal. Corresponding personal data can, for example, be master data, variable data, disclosed data or observed data. Furthermore, such data can be statistically determined or prepared data according to what is called “data mining”. Concretely, such personal data can be the user's address, date of birth, religion, current domicile, family status, interests, profession, websites visited, websites evaluated, etc. As an alternative or in addition, the selection data used can be data provided by the computer infrastructure, for example, the current weather, current events, etc. It is also conceivable that, as an alternative or in addition to the aforementioned data, data of a user of the second terminal can also be used as selection data.

In further advantageous manner, the first terminal and the at least one second terminal can communicate with each other in a direct manner—peer-to-peer. Furthermore, it is conceivable that the first terminal and the at least one second terminal can communicate with each other in an indirect manner, for example, via the server of the external processing unit. At this point, it should be expressly noted that the method according to the invention is not mandatorily a method for communication between two terminals. In fact, any number of terminals desired can participate in communication. In addition to the communication data, information data can, therein, also be transferred to some or all of the terminals participating in communication. Therein, the information data to be transferred are selected as described above. Consequently, the method according to the invention is not limited to a single first terminal. In other words, the number of first terminals communicating with each other can be as high as desired.

Furthermore, the aforementioned problem is solved by means of a terminal according to Claim 14.

Therein, it is conceivable that a display device formed to present different data on different, more particularly two, visual planes is formed in the terminal according to the invention.

Furthermore, it should be noted that the above-discussed features of the method according to the invention may also have a device-related expression. The combination of these features with the device claims referring to the terminal is not only possible but advantageous.

There are various options of embodying and refining the teaching of the present invention in advantageous manner. To this end, reference is made to the claims that are subordinate to Claims 1 and 14 on the one hand and, on the other hand, to the following illustration of preferred exemplary embodiments of the invention by means of the drawing. Generally preferred embodiments and refinements of the teaching will also be illustrated in the context of the illustration of the preferred exemplary embodiments of the invention by means of the drawing. In the drawing,

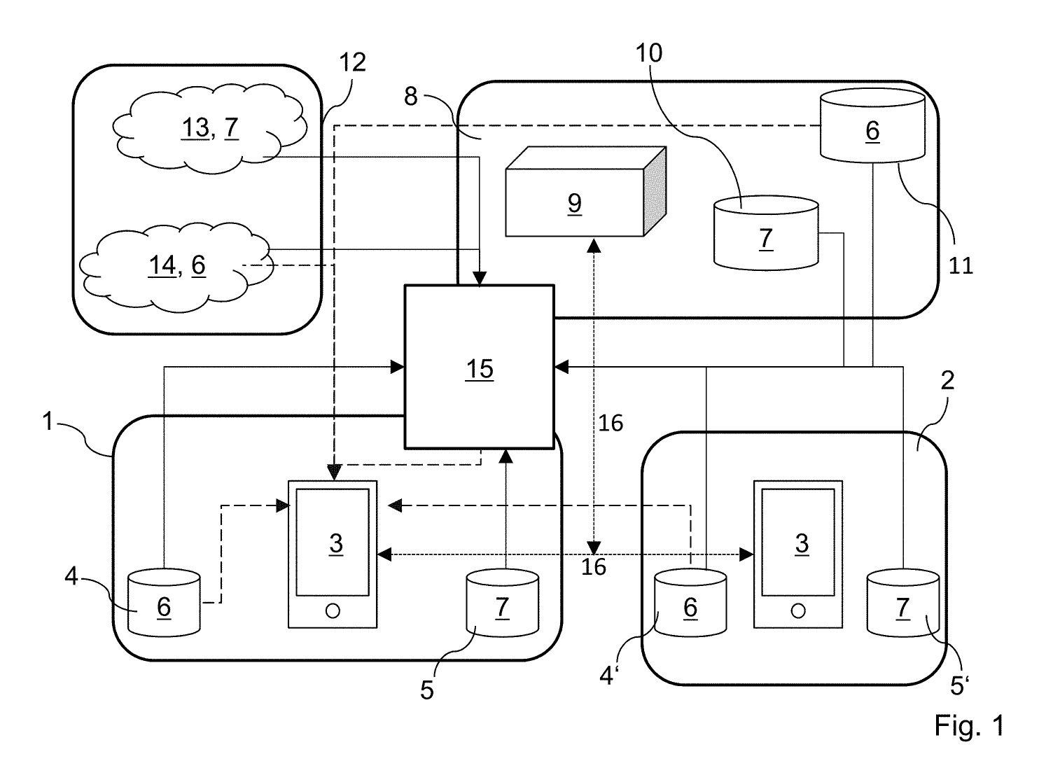

FIG. 1 is a schematic block diagram of an exemplary embodiment of the components of the method according to the invention;

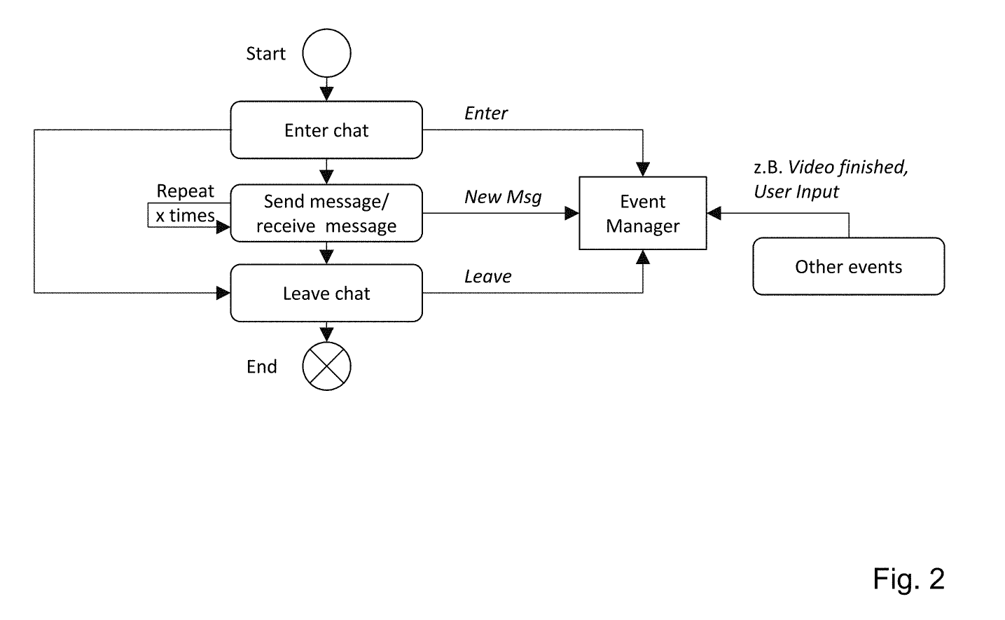

FIG. 2 is a schematic block diagram of an exemplary embodiment of the process of the method according to the invention;

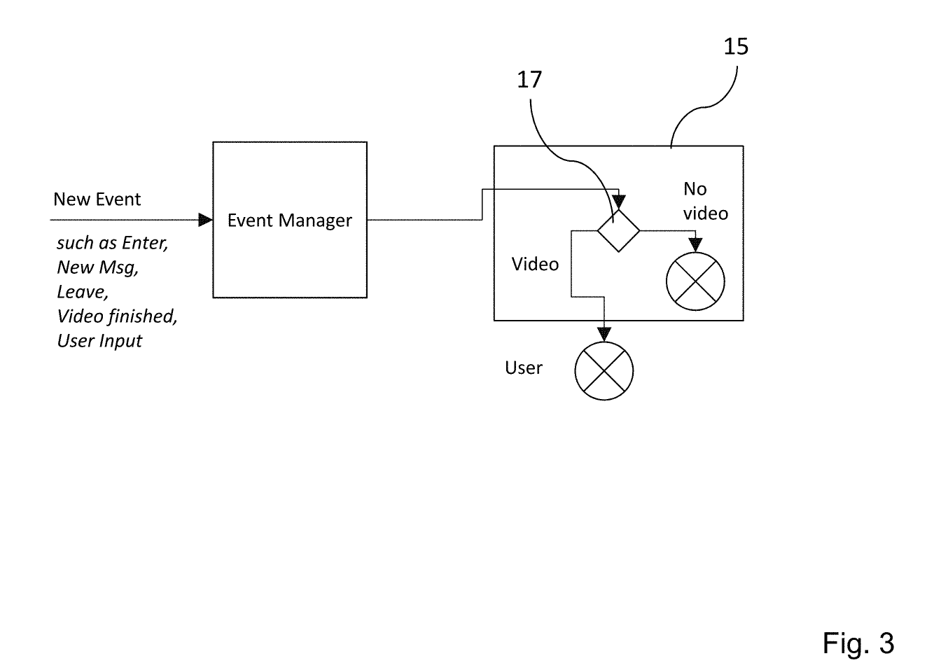

FIG. 3 is a schematic block diagram of an exemplary embodiment of the function of a selection unit according to the invention; and

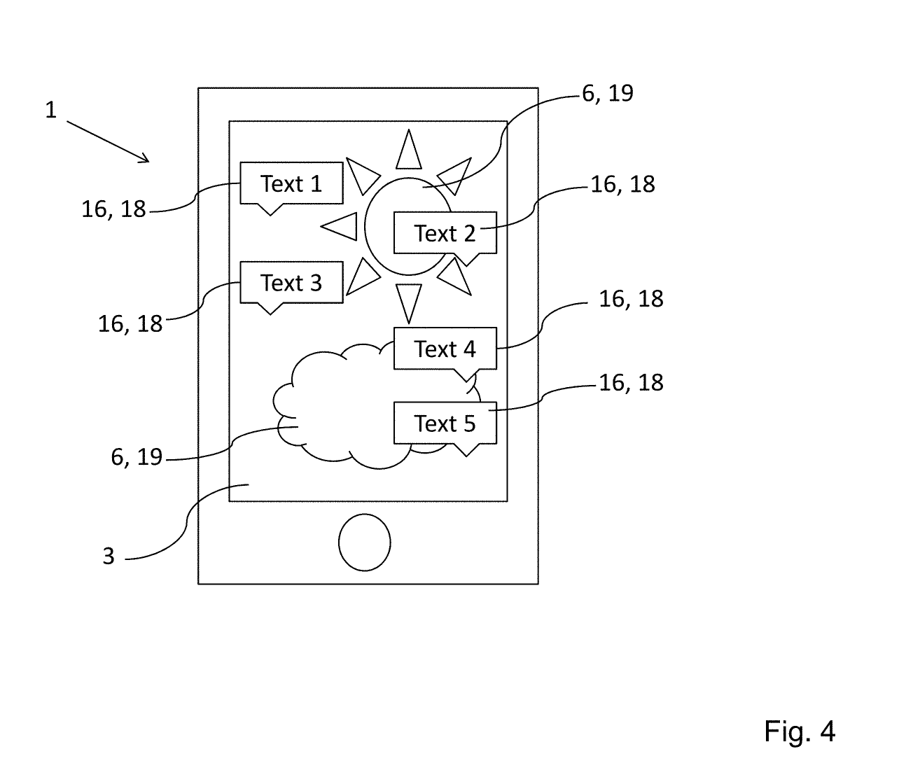

FIG. 4 is a schematic diagram of an exemplary embodiment of a terminal according to the invention.

FIG. 1 is a schematic block diagram of an exemplary embodiment of the components of the method according to the invention. The method serves for communication between a first terminal 1 and at least one second terminal 2. Therein, it is essential that any number of further second terminals 2 can participate in communication.

The first terminal 1 and the second terminal 2 each feature a display device 3 for the presentation of data. Furthermore, the first terminal 1 comprises a first database 4 and a second database 5. Information data 6, for example, animations and/or moving pictures and/or audiovisual sequences, such as promotional videos, video streams, movie trailers, etc., can be stored in the first database 4. Personal data of the user of the first terminal can be stored in the second database 5 as selection data 7, for example, master data and/or variable data.

The second terminal 2 also comprises a first database 4′ and a second database 5′. Information data 6, for example, animations and/or moving pictures and/or audiovisual sequences can be stored in the first database 4′ of the second terminal. Further data of the user of the second terminal can be stored in the second database 5′ as selection data 7.

Furthermore, FIG. 1 shows an external processing unit. The external processing unit 8 comprises a server 9 as well as a first database 10 and a second database 11. The first database 10 can comprise personal data of the user of the first terminal 1 as selection data 7, for example, master data and/or variable data. Furthermore, the first database 10 of the external processing unit 8 can contain data of the user of the first terminal 1 as selection data 7 that have been transferred to the external processing unit 8 or have been observed or statistically determined (what is called “data mining”) by said external processing unit 8.

Furthermore, FIG. 1 shows a computer infrastructure 12 of one or a plurality of information providers. Such information providers can be providers of video clips, news services, weather services, event services, etc. The external computer infrastructure 12 provides external data 13, more particularly the current weather report, events, etc., as selection data 7, and/or external audiovisual information 14, more particularly video clips and/or promotional videos, as information data 6.

The first terminal 1, the second terminal 2, the external processing unit 8 as well as the computer infrastructure 12 can communicate with a selection unit 15. The selection unit 15 can be implemented by the first terminal 1 or by the external processing unit 8.

Furthermore, it can be seen from FIG. 1 that the first terminal 1 can communicate with the second terminal 2 either in a direct manner—peer-to-peer—or in an indirect manner, i.e., via the server 9 of the external processing unit 8. The communication data 16 that are transferred from the second terminal 2 to the first terminal 1 are presented on the display device 3 of the first terminal 1. Furthermore, the selection unit 15 uses the selection data 7 to select the information data 6 that are transferred to the first terminal 1 and presented on the display device 3.

While communication between the first terminal 1 and the second terminal 2 is in progress, the second terminal 2 transfers communication data 16 to the first terminal 1, said communication data 16 then being presented on the display device 3. Furthermore, information data 6 of the first terminal 1 and/or the second terminal 2 and/or the external processing unit 8 and/or the computer infrastructure 12 are selected by the selection unit 15 and presented on the display device 3 of the first terminal 1. The first terminal 1 and/or the second terminal 2 and/or the external processing unit 8 and/or the computer infrastructure 12 can therefore each serve as information unit.

FIG. 2 is a schematic block diagram of an exemplary embodiment of a process of the method according to the invention. The method starts when the user of the first terminal 1 enters the chat. Therein, an “Enter” event is transferred to an event manager. While communication of the first terminal 1 with the second terminal 2 is in progress, i.e., while the chat is in progress, communication data 16—more particularly messages—can be transferred between the terminals 1, 2. Whenever a message is transferred, a “New Msg” event is transferred to the event manager.

After the chat has been left, i.e., after communication between the first terminal 1 and the second terminal 2 has been finished, a “Leave” event is sent to the event manager.

While communication is in progress, the event manager is additionally able to listen in to events that do not relate to the communication between the first terminal 1 and the second terminal 2, for example, whether the first terminal 1 and/or the second terminal 2 has/have finished the presentation of information data 6, more particularly of audiovisual information, such as a video or a video stream. In such a case, the “Video finished” event is transferred to the event manager. Furthermore, such an event can be another input made by the user, with the result that the “User Input” is transferred to the event manager.

FIG. 3 is a schematic block diagram of an exemplary embodiment of the function of a selection unit 15 according to the invention. Therein, events transferred to the event manager are transferred from the event manager to the selection unit 15. Furthermore, the first terminal 1 and/or the second terminal 2 and/or the external processing unit 8 and/or the computer infrastructure 12 transfers selection data 7 to the selection unit 15; to simplify matters, this is not shown in FIG. 3. Based on the events and the selection data 7, a logic 17 in the selection unit 15 defines whether and which information data 6 are transferred to the first terminal 1.

FIG. 4 is a schematic diagram of an exemplary embodiment of a first terminal 1 according to the invention for applying the method according to the invention.

The first terminal 1 comprises a display device 3 for presenting the communication data 16 and the information data 6. Therein, the display device 3 is formed such that the communication data 16 are displayed on a first visual plane 18 and the information data 6 are displayed on a second visual plane 19. Therein, the second visual plane 19 is disposed in the background of the first visual plane 19 as seen by the viewer. Consequently, the communication data 16 overlap the information data 6 at least in part.

As regards further advantageous embodiments of the method according to the invention and the device according to the invention, reference is made to the general part of the description as well as to the appended claims in order to avoid repetitions.

Finally, it should be expressly noted that the above-described exemplary embodiments of the teaching according to the invention only serve to illustrate the claimed teaching but are not limited to the exemplary embodiments.

### LIST OF REFERENCE NUMBERS

1 First terminal
2 Second terminal
3 Display device
4, 4′ First database
5, 5′ Second database
6 Information data
7 Selection data
8 External processing unit
9 Server
10 First database
11 Second database
12 Computer infrastructure
13 External data
14 External audiovisual information
15 Selection unit
16 Communication data

1. A method for communication between at least two terminals (1, 2) via a network, wherein a first terminal (1) comprising a display device (3), at least one second terminal (2) and an information unit are provided, wherein the information unit transfers information data (6) to the first terminal (1), preferably via the network, wherein the second terminal (2) transfers communication data (16) to the first terminal (1) via the network, wherein the communication data (16) are presented on a first visual plane (18) of the display device (3) and wherein the information data (6) are presented on a second visual plane (19) of the display device (3).

2. The method according to claim 1, characterised in that the communication data (16) on the first visual plane (18) are, at least in part, presented transparently and/or semi-transparently.

3. The method according to claim 1 or 2, characterised in that the presentation of the colours and/or the brightness of the communication data (16) on the first visual plane (18) is, at least in part, adjusted to the presentation of the colours and/or the brightness of the information data (6) on the second visual plane (19).

4. The method according to any one of claims 1 to 3, characterised in that the information data (6) are animations and/or moving pictures and/or audiovisual sequences, more particularly promotional videos, video streams, movie trailers, etc.

5. The method according to any one of claims 1 to 4, characterised in that the information data (6) are presented in full screen mode or in a smaller size and/or with a lower resolution than the resolution of the display device (3).

6. The method according to any one of claims 1 to 5, characterised in that the communication data (16) are messages, particularly text messages, audible sequences, audiovisual sequences, pictures, video clips, graphics, current position data of the user and/or emoticons.

7. The method according to any one of claims 1 to 6, characterised in that the first terminal (1) and/or the second terminal (2) is/are a desktop computer, a laptop, a notebook, a tablet computer, a smart phone, a PDA, etc.

8. The method according to any one of claims 1 to 7, characterised in that the information unit is implemented by the first terminal (1) and/or by the second terminal (2) and/or by an external processing unit (8) that communicates via the network and comprises a server (9) and at least one database and/or by a computer infrastructure (12) that communicates via the network and is offered by one or a plurality of information providers.

9. The method according to any one of claims 1 to 8, characterised in that the information data (6) to be transferred to the first terminal (1) are selected by a selection unit (15).

10. The method according to claim 9, characterised in that the selection unit (15) is implemented by the first terminal (1) or by the external processing unit (8).

11. The method according to claim 9 or 10, characterised in that the information data (6) to be transferred from the selection unit (15) to the first terminal (1) are selected in due consideration of selection data (7), wherein the selection data (7) are transferred from the first terminal (1) and/or the second terminal (2) and/or the external processing unit (8) and/or the computer infrastructure (12) to the selection unit (15).

12. The method according to claim 11, characterised in that the selection data (7) are personal data of a user of the first terminal (1), for example, address, date of birth, religion, current domicile, family status, interests, profession, websites visited, websites evaluated, etc., and/or data provided by the computer infrastructure (12), for example, weather, current events etc. and/or data of a user of the second terminal (2).

13. The method according to any one of claims 1 to 12, characterised in that the first terminal (1) and the at least one second terminal (2) communicate with each other in a direct manner or in an indirect manner—via the external processing unit (8).

14. A terminal for applying the method according to any one of claims 1 to 13.

15. The terminal according to claim 14, characterised in that a display device is arranged that is formed to present different data on different, more particularly two, visual planes (18, 19).
